(19) United States
(12) Patent Application Publication
(10) Pub. No.: US 2002/0073149 A1
(43) Pub. Date: Jun. 13, 2002

(54) Dynamic content linking

(76) Inventor: Christopher Tyler Young, Studio City, CA (US)

Correspondence Address: David A. Belasco, Esq., BEEHLER & PAVITT, Suite 330, 100 Corporate Pointe, Culver City, CA, 90230, US

(21) Appl. No.: 09/974,422

(22) Filed: Oct. 9, 2001

Related U.S. Application Data
(60) Provisional application No. 60/239,680, filed on Oct. 11, 2000.

(51) Int. Cl. G06F 15/16

(52) U.S. Cl. 709/204; 709/231

(57) ABSTRACT

A system and methods for dynamically linking changing media content to other media content is described. A network system includes Websites suitable for use by wired and wireless users. The wired Web sites include Web pages providing content that changes over time, such as a video or animation clip. Imbedded within these Web pages are links to other media content. These links are both time and location dependent within the changing content. A link map identifies all of the other media content associated with the imbedded links. A program associated with the changing content page and incorporating the link map provides means to capture the time and location of a user's link selection and provides instructions to the wired Web site to store the linked media content associated with the selected link in a storage location. Means are provided for the wired user to instruct the wired Web site to send the stored media content to either a wired or wireless user connected to the network system. Likewise, Web pages that are static can also contain links to other media content. A wired user may select these links, store the associated media content and then transmit the content to another connected user.

### FIELD OF INVENTION

The present invention relates to hypermedia systems for selection and delivery of content over computer networks, and more particularly, to a hypermedia system that provides a time-dependent matrix of hyperlinks within a sequence of animated content, wherein selection of a hyperlink causes specific content to be delivered to a client device, and in particular, to a mobile device employing a wireless protocol such as i-mode or WAP (Wireless Application Protocol).

### BACKGROUND OF THE INVENTION

Systems for wireless data transmission to mobile devices are rapidly being developed; for example, the “i-mode” cell phone system in use and under development by NTT Mobile Communications Network, Inc. (“NTT DoCoMo”) of Tokyo, Japan. In the United States, various wireless data transmission technologies, typically classified as either two-and-a-half generation (“2.5G”) or third generation (“3G”), are being contemplated or developed by telecommunications providers. 2.5G technologies provide wireless data transmission rates of about 115 Kbps to less than about 384 Kbps, and 3G technologies are capable of data transmission at 384 Kbs to about 2 Mbps. Meanwhile, even at slower data transmission rates, such as the 9.6 and 14 Kbps rates typical of many current cellular systems, protocols for Internet services are available. For example, a “microbrowser” for Internet services at currently prevalent transmission rates using the WAP is available from Openwave, Inc., of Redwood City, Calif.

All of the foregoing trends are propelling rapid growth in the use of mobile devices for accessing information on the Internet. At the same time, information available on the Internet, and particularly, on the World Wide Web (the “Web”), is becoming increasingly rich and oriented towards high-bandwidth video information and multimedia entertainment, as the bandwidth and processing power of the Internet continues to grow. However, Web content that is formatted for standard computer displays, which typically measure at least about 14″ diagonally, is not well suited for mobile devices, with their relatively small (about 2″ to 4″) video screens. Even when bandwidth and transmission rates are not an issue, regular Web content is much more usable by mobile users when formatted to fit on small screens.

Currently, a few Internet content providers maintain websites for serving content formatted for mobile devices, and this is a trend that is expected to continue as mobile Web usage grows.

Increased use of richer, high-bandwidth Internet content in conjunction with mobile Internet devices has created a demand for linking content between wireless and wired protocols. Linked content comprises parallel, complementary sets of information, such as a set of Web pages developed for regular Internet usage, and a related set of Web pages for wireless devices. For example, a first set of information might be today's regular edition of an on-line newspaper for general Web publication in HTML (hypertext markup language) format, and the linked content might be an abridged version of today's news, formatted to fit on small screens. Linked content is typically static after being created by the content publisher, as is the link between the content. That is, the content and the relationship (or “link”) between it does not change with time. One merely selects one or the other set of information to view, depending on the desired display format.

Static linked content is useful, particularly for textual information, but does not fully exploit the capability of the Internet and the Web to provide time-dependent links between time-dependent content (such as video) and other linked content. For example, someone viewing a multimedia video presentation over a wired Internet connection can only select static links within the presentation itself. Thus, although the content and focus of the video presentation change during its playtime, the links to related content do not. For example, users arrive at a single linked destination (Web page, image, sound, or animation) when they select a link within an animated sequence, regardless of when they select the link. If such links could also be made time-dependent, so that the destination depended on when the user selected the link, the multimedia viewer would have more convenient access to related content, indexed to specific, time-dependent portions of the video presentation. A need therefore exists to link Web content in a more dynamic fashion.

### SUMMARY OF THE INVENTION

“Dynamic Content Linking” or “DCL,” as used herein, refers to a time-dependent sequence of different links to other content embedded in a time-dependent Web object. The linked content may be formatted in different protocols, such as i-mode or WAP, or in the same protocol. Practical applications for DCL are enormous, ranging from enhanced entertainment to powerful marketing and advertising tools.

In a first embodiment of the invention, dynamic links are established between an animation Web object and other content. A user viewing an animation using the Web object can select different animated characters to be directed to other linked content and dialogue. For example, a user viewing an animation might find one of the character poses particularly amusing, and click on the character during the pose. The user would then receive an animation “still” of the character in the desired pose, which could be displayed, if desired, in a separate window. The related content is not limited to non-animated content, but may comprise another related animation, such as a partial or miniature sequence of the animation, or another animation, or a multimedia or still advertisement. Any type of content may be linked to the animation in this way.

The invention further provides for formatting linked content according to an alternate protocol, storage of linked content, and transmission of the content to a wireless mobile device. For example, a user viewing an animation on-line might find a particular joke particularly funny and relevant for a friend of the user, whom the user knows has a suitable mobile Internet device, such as a WAP-enabled cellular phone. The user would click on the character during or shortly after the joke, causing a particular mini-animation sequence containing the joke, formatted for a WAP device, to be stored in a portion of computer memory assigned to the user. The user could then send the sequence to her friend's cell phone or e-mail by selecting a “send” option and providing the appropriate phone number or Internet address.

The present invention is not limited to linking content to animations. Any content suitable for display with an HTML-compatible browser may take advantage of DCL. For example, DCL may be used with a multimedia display of a movie, so that a user could link to different content during different portions of the movie. If a user wanted more information about a pair of sunglasses worn by an actor in the movie, the user could click on the sunglasses to obtain information about purchasing them. For versatile application to different content, the present invention provides each DCL Web page with a map of numbered coordinates that are a function of position on the page, and time (specific portion of each multimedia sequence). When a user sees or hears a particular segment that piques his interest, he clicks on (or otherwise selects) that segment. The coordinates (both position and time) of the click (or other method of selection) identify and call a Perl and PHP (PHP: Hypertext Preprocessor) script (from O'Reilly & Associates of Sebastopol, Calif.), which in turn call the appropriate linked content identified by the coordinates. In an embodiment of the invention, the Perl and PHP script refreshes the original source to reflect the linked content that the user has selected. If desired, Flashy® script (from Macromedia, Inc. of San Francisco, Calif.) and a suitable database engine are used to send the linked content through a wireless information gateway to the wireless device of choice.

A more complete understanding of the dynamic content linking will be afforded to those skilled in the art, as well as a realization of additional advantages and objects thereof, by a consideration of the following detailed description of the preferred embodiment. Reference will be made to the appended sheets of drawings that will first be described briefly.

### DESCRIPTION OF THE DRAWINGS

FIG. 1 is a block diagram mapping pages of a Web site for DCL according to the invention;

FIG. 2 is a block diagram showing elements of a DCL site for wired users and a related DCL site for wireless users;

FIG. 3 is a flow chart showing exemplary steps of a method for implementing a web site according to the present invention;

FIG. 4 is a flow chart showing exemplary steps of a method for producing DCL content according to the present invention;

FIG. 5A shows an exemplary screen shot of DCL content at a first instant of time, and the position of animated objects and a value of link identifiers at that instant; and

FIG. 5B shown the DCL content of FIG. 5A at a second instant of time, and the position of animated objects and a value of link identifiers at that second instant.

### DETAILED DESCRIPTION OF THE PREFERRED EMBODIMENT

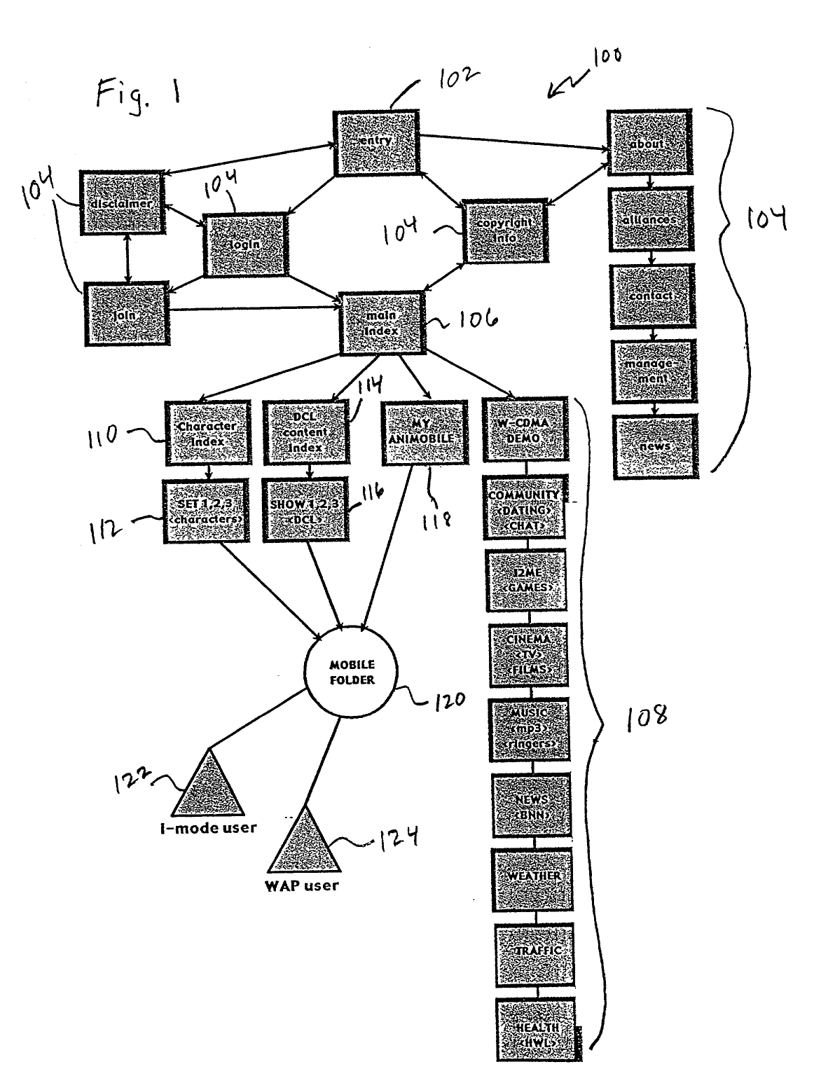

The present invention provides for Dynamic Content Linking (DCL) between related content, and in particular, for DCL wherein the linked content is formatted for, and transmitted to, mobile Internet devices. Referring to FIG. 1, showing block diagram mapping pages of a Web site for DCL, the invention is preferably implemented as part of a web site 100 for information or entertainment. In the present example, web site 100 is for providing animated entertainment, but other types of dynamic content (content which changes during its presentation), such as video clips or scripted web pages, are also suitable. Web site 100 preferably comprises an entry page 102, and a set of administrative pages 104, as known in the art, for user customer accounts and facilitating user service and support. Web site 100 additionally comprises content index page 110, indexing the animated characters that may be accessed on the site, DCL content index 114, indexing the DCL programs on the site, pages 112 with the animated characters, and pages 116 with the DCL content comprising animated programs for display using a suitable web browser, as known in the art. Site 100 optionally includes personalized pages 118.

A user viewing pages 116 may select secondary linked content, which is dynamically linked to animated programs accessible from pages 116, to be stored in mobile folder 120. Folder 120 preferably comprises computer memory allocated for the user's use. Preferably, a user may also select statically linked content, such as static views of animated characters available on pages 112, for inclusion in folder 120. The user may then select content from folder 120 for sending to various mobile users, such as i-mode user 122 and WAP user 124.

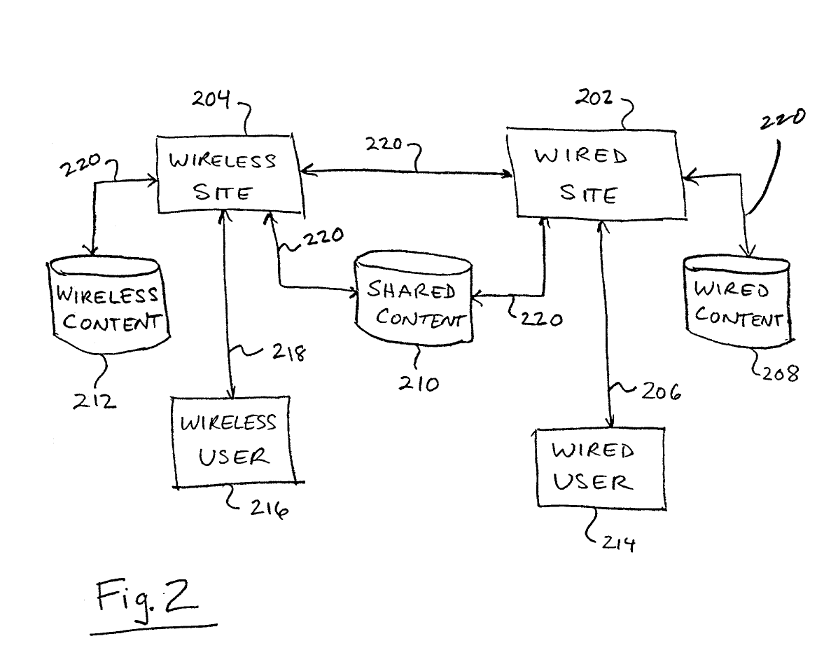

FIG. 2 shows elements of a wide area network system 200 for performing a DCL method according to the invention. System 200 comprises at least one wired web site 202 connected to a wired user 214 by communication link 206. Communication link 206 comprises various fiber optic, wire, or other hardware connections carrying data according to a standard protocol, such as TCP/IP (Transmission Control Protocol/Internet Protocol). Wired web site 202 is connected to certain information, such as to wired content stored in database 208, by an internal link 220, which is typically an internal bus or hardware connection. Wired user 214 typically connects to system 200 using a personal computer or other computing device, running a web browser such as Microsoft Internet Explorer® or Netscape Communicator®. Wired site 202 serves web pages, including DCL pages formatted according to protocols known in the art, such as HTML and PHP, to wired user 214. System 200 preferably includes a wireless site 204 connected to the wired site 202 by hardware links 220 (or by communication links 206) and to a wireless user 216 by wireless communication link 218. Wireless user 216 typically connects to system 200 using a mobile device, such as a cellular phone running a WAP or i-mode compatible web browser. Wireless site 204 connects to database 212 for access to content formatted specifically for wireless user 216, and to a database 210 of shared content, which it shares with wired site 202.

To make use of DCL according to the invention, wired user 214 requests access to wired content in database 208 through wired site 202. The wired site 202 serves a web page containing a dynamic linked object, such as a web page with an embedded animation scripted using Flash® script playable in a Macromedia® web player from Macromedia, Inc., of San Francisco, Calif. The web page is provided with dynamic links as described herein. While viewing the animated script, the wired user 214 selects a link on the web page at a particular time. Selection of the link causes wired site 202 to identify specific linked content and store it in a database 210 of shared content. At a later time, wired user 214 directs wired site 202 to send specific content in database 210 to wireless user 216 (or to any other specified user connected to system 200). Wired site 202 processes the wired user's 214 instruction and forwards an appropriate message to wireless site 204, which retrieves the specified content from database 210 and sends it to wireless user 216. Conversely, wireless user 216 may view a database of wireless content 212, and may send specified portions of it to wired user 214 in a similar fashion.

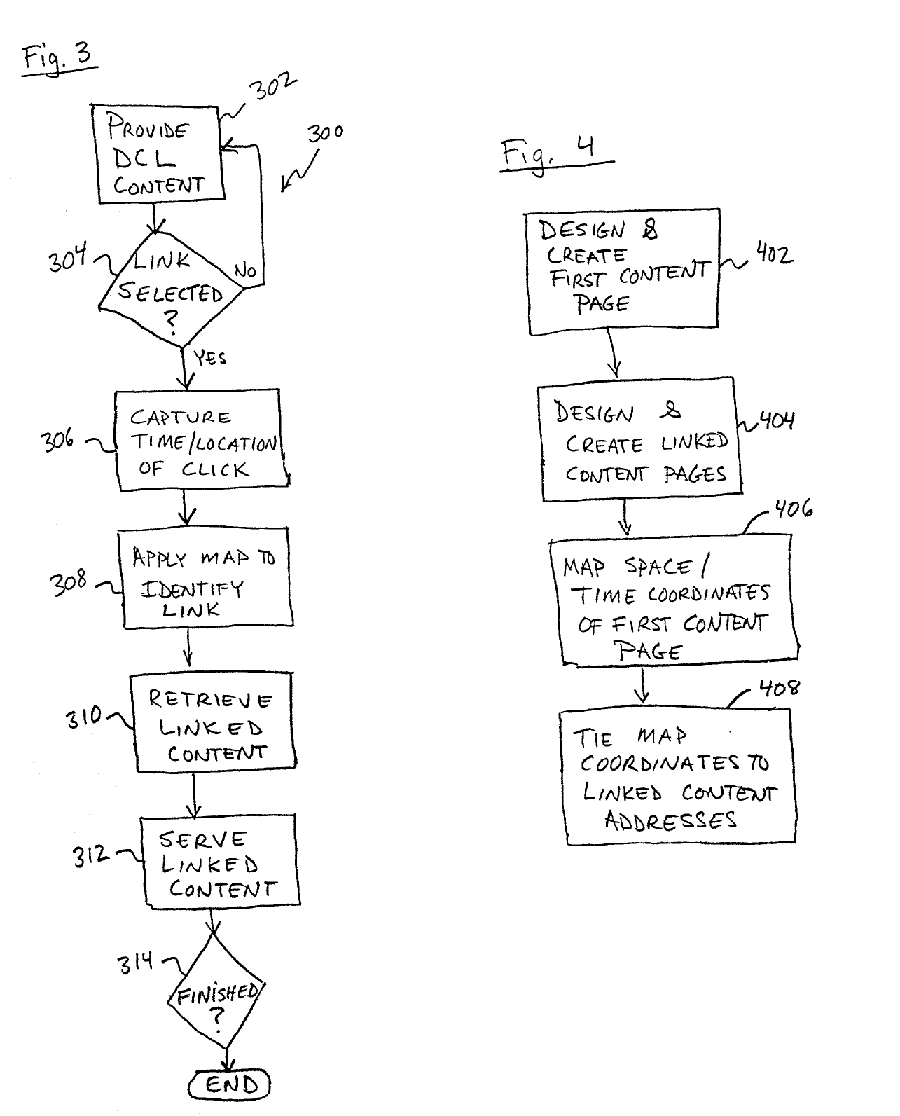

FIG. 3 shows exemplary steps of a method 300 for implementing a web site according to the present invention. In an initial step 302, first content with dynamic links is provided at a wired site. Further details of providing content with dynamic links are provided in connection with FIG. 4. The dynamically linked content is served to a wired user until the user, selects one of the dynamic links by performing a selection action such as clicking on a object or area of the screen using a computer mouse or other pointing device, at step 304. At step 306, the time and location of the mouse click are captured using a programming routine as known in the art, such as a PHP script or C program routine. At step 308, the time and location of the mouse click are further processed using a content map linked to the first content, to identify linked content. At step 310, the linked content is retrieved from content database using an identifier obtained at step 308. At step 312, the linked content is provided to a predetermined location. For example, the content could be provided in a separate browser window to the requesting user. Preferably, the first content script continues playing while steps 304-312 are performed, i.e., until it is finished, as determined at step 314.

FIG. 4 shows exemplary steps of a method 400 for producing DCL content according to the present invention. In an initial step 402, a first content page is designed and created. The first content page for DCL is preferably an engaging media presentation with discrete, selectable elements that may be played on a readily available, Internet and Web-compatible browser. Examples include animated sequences, both of cartoons and computer generated graphics, and video presentations adapted or converted from television or movies. Animated clips are particularly suitable, because every element in the animated sequence is carefully drawn and designed, frame-by-frame. In a following step 404, a set of one or more (preferably, many) related content pages are designed to correspond with elements of the first content. A related page may be as complex or more complex than the first content page, and have its own dynamic links; but more typically, the related pages comprise simplified portions or derivations of the first content, so as to not overly distract from it. Furthermore, as previously described, in a embodiment of the invention, the related content comprises abridged characters or abbreviated vignettes suitable for transmitting and displaying on a narrower-bandwidth, small display device such as a mobile phone. In another embodiment, the related content can be readily e-mailed to either or both of wired and wireless users. Content design and creation is as known in the art of media design for web applications.

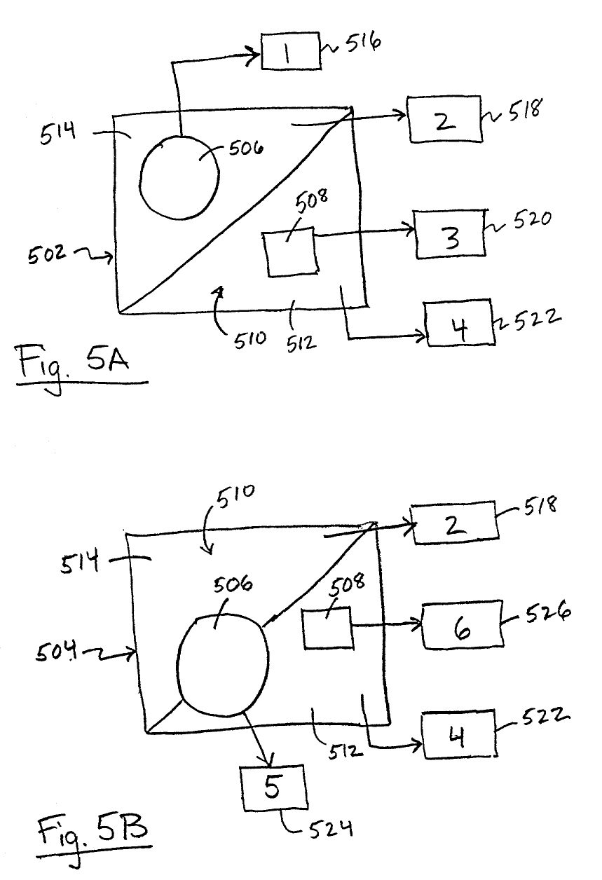

At step 406, a link map of the first content page is created. This requires designating objects or areas on the content page to correspond to selected related content pages at specified times during display of the first content page (or for specified frames if the first content is a media file). After the desired map is created, it is implemented as a programming script, preferably using Perl (Practical Extraction Report Language) and PHP, a server-side HTML embedded scripting language developed by the PHP Development Team (www.php.net); other programming methods may optionally be used, if desired. Implementation includes writing code to capture the time (or frame) and location of a selection action (such as a mouse click) taken by someone viewing the first content page, and returning an appropriate content identifier to the server depending the time and location selected. The completed code is incorporated into the first content page as known in the art. Finally, at step 408, each identifier is associated with specific content according to database techniques known in the art, so that the act of passing a content identifier causes a database to extract the relevant related content and deliver it to a specified address. FIGS. 5A and 5B show exemplary screen shots 502 and 504 of DCL content at first and second instants of time. Each screen 502 and 504 contain two animated objects 506 and 508, and a background 510 divided into two areas 512 and 514. In screen 502, animated object 506 is linked to a first identifier 516, which is in turn linked to specific related content in a database 208, 210 as illustrated in FIG. 2, and the background surrounding object 506 is linked to a second identifier 518. Similarly, animated object 508 is linked to a third identifier 520 and its background 512 is linked to a fourth identifier 522. At a later time, such as when frame 504 appears one or more frames after frame 502, objects 506 and 508 have moved relative to their respective backgrounds, as shown in FIG. 5B. In this example, their mapped identifiers have changed also, with object 506 now mapped to a fifth identifier 524 and object 508 mapped to a sixth identifier 526. Meanwhile, in this example, the identifiers 518 and 522 for areas 514 and 512, respectively, have not changed, although it should be understood that these could also be selected to change, if desired.

Having thus described a preferred embodiment of dynamic content linking, it should be apparent to those skilled in the art that certain advantages of the within system have been achieved. It should also be appreciated that various modifications, adaptations, and alternative embodiments thereof may be made within the scope and spirit of the present invention. For example, dynamic content linking for use with mobile wireless technology has been illustrated, but it should be apparent that the inventive concepts described above would be equally applicable to dynamic content linking between other protocols, or within a protocol.

1. A system for dynamically linking changing media content to other media content comprising:
a network Web site, said Web site comprising a plurality of Web pages; and
at least one of said Web pages comprising media content that changes during presentation, said changing media content comprising time dependent links to other media content.

2. A system for dynamically linking changing media content to other media content, as described in claim 1, further comprising:
a storage folder, said storage folder comprising computer memory allocated for use of a Web site user;
means for said user to view said changing media content;
means for said user to select said other media content linked to said changing media content;
means for said user to store said other media content in said storage folder;
means for said user to select said stored other media content from said storage folder and transmit same to either of a wired and a wireless user; and
whereby, when said user selects said other media content linked to media content that changes during presentation, said user may store and later select said other media content for transmission to either of wired and wireless users.

3. A system for dynamically linking changing media content to other media content, as described in claim 1, further comprising at least one Web page comprising media content that is static during presentation, said static media content comprising links to other media content.

4. A system for dynamically linking changing media content to other media content, as described in claim 3, further comprising:
a storage folder, said storage folder comprising computer memory allocated for use of a Web site user;
means for said user to view said static media content;
means for said user to select said other media content linked to said static media content;
means for said user to store said other media content in said storage folder; and
whereby, when said user selects said other media content linked to media content that is static during presentation, said user may store and later select said other media content for transmission to either of wired and wireless users.

5. A system for dynamically linking changing media content to other media content comprising:
a network system, said system comprising at least one wired Web site;
said wired Web site being connected to at least one wired user by a communication link;
said communication link comprising either of wire, fiber optic and hardware connections carrying data to and from said wired Web site according to a standard protocol;
said wired user connecting to said network system using either of a personal computer and another communications device connected to said communication link;
a wired content database, said wired content database being a data storage device containing content suitable for viewing by users over a wired connection to said network system;
said wired content database being connected to said wired Web site by either of an internal link and a communication link;
said internal link comprising either of an internal bus connection and a hardware connection;
said wired Web site providing content from said wired content database to said wired user; and
said content from said wired content database comprising Web pages, at least one of said Web pages comprising media content that changes during presentation, said changing media content comprising time dependent links to other media content.

6. A system for dynamically linking changing media content to other media content, as described in claim 5, further comprising:
a shared content database, said shared content database being a data storage device containing content suitable for viewing by users over either of a wireless connection and a wired connection to said network system;
said shared content database being connected to said wired Web site by either of internal links and communication links;
means for said wired user to select said time dependent links to other media content from said media content that changes during presentation stored in said wired content database;
said selection causing said wired Web site to identify and store said linked other media content in said shared content database;
means for said wired user to direct said wired Web site to send content stored in said shared content database to either of wired and wireless users connected to said network system; and
whereby, when said wired user selects said time dependent links to other media content from said media content that changes during presentation stored in said wired content database, the linked content will be stored in the shared content database for later transmission to either of wired and wireless users connected to said network system.

7. A system for dynamically linking changing media content to other media content, as described in claim 6, wherein the means for the wired user to select the time dependent links to other media content further comprises:
a link map of a first Web page, said first Web page comprising media content that changes during presentation, said link map designating at least one selectable element of said first Web page to correspond to said other media content at either of specified times and specified frames during display of said first Web page;
said selectable elements comprising either of discrete, selectable objects and areas of said first Web page;
a program, said program being designed to capture the location and either of the time and frame of an action selecting said selectable elements;
said program being incorporated into said first Web page and using said location and either of time and frame information and said link map to identify a link to specific other media content; and
means for using said identified link to extract said specific other media content for delivery to a specified location.

8. A system for dynamically linking changing media content to other media content, as described in, claim 6, further comprising:
at least one wireless Web site;
said wireless Web site being connected to said wired Web site by either of an internal link and a communication link;
said wireless Web site being connected to said shared content database by either of an internal link and a communication link;
said wireless Web site being connected to a wireless user by a wireless communication link;
said wireless user connecting to said wide area network system using either of a cellular phone and a mobile device;
a wireless content database, said wireless content database being a data storage device containing content suitable for viewing by users over a wireless connection to said network system;
said wireless content database being connected to said wireless Web site by either of an internal link and a communication link;
means for said wireless user view and select content from said wireless database; and
means for said wireless user to direct said wireless Web site to transmit said selected content to either of a wired and wireless user connected to said network system.

9. A system for dynamically linking changing media content to other media content, as described in claim 6, wherein the means for said wired user to direct transmission of the linked other media content further comprises:
means for said wired Web site to process said direction from said wired user; and
said processing resulting in instructions to said wireless Web site to retrieve identified content stored in said shared content database and send said identified content to either of a wired and a wireless user.

10. A method for implementing a Web site for dynamically linking changing media content to other media content comprising the following steps:
providing a network system, said system comprising at least one wired Web site;
providing a wired content database connected to said wired Web site, said wired content database being a data storage device containing content suitable for viewing by users over a wired connection to said network system; and
said content from said wired content database comprising Web pages, at least one of said Web pages comprising media content that changes during presentation, said changing media content comprising time dependent links to other media content.

11. A method for implementing a Web site for dynamically linking changing media content to other media content, as described in claim 10, comprising the following additional steps:
serving content from said wired content database comprising said time dependent links to other media content to said wired user until one of said time dependent links is selected by said user;
capturing the time and location of said selected link;
processing the captured time and location of said selected link using a content map, said content map being identified to said content from which said user selected said time dependent link, said content map identifying said other media content associated with said selected link;
retrieving said other media content associated with said selected link;
providing said other media content associated with said selected link to a predetermined location; and
serving further content from said wired content database until either of further links are selected by said user and said content is completed.

12. A method for dynamically linking changing media content to other media content comprising the following steps:
creating a first Web page, said first Web page comprising media content that changes during presentation and comprising at least one discrete, selectable element, said selectable element comprising either of discrete, selectable objects and areas of said first Web page;
creating at least one related content page, said related content page corresponding to said selectable element of said first content page;
preparing a link map of said first Web page, said link map designating said selectable elements of said first Web page to correspond to said related content pages at either of specified times and specified frames during display of said first Web page;
creating a program to capture the location and either of the time and frame of an action selecting said selectable element of said first Web page;
incorporating said program into said first Web page;
using said location and either of time and frame information and said link map to identify a link to one of said related content pages;
using said identified link to extract a relevant related content page; and
delivering said extracted related content page to a specified location.
